(19) United States
(12) Patent Application Publication
(10) Pub. No.: US 2002/0163511 A1
(43) Pub. Date: Nov. 7, 2002

(54) Optical position determination on any surface

(76) Inventor: Oral Faith Sekendur, Chicago, IL (US)

Correspondence Address: ORAL SEKENDUR, 399 W. FULLERTON PKWY., CHICAGO, IL, 60614, US

(21) Appl. No.: 10/134,112

(22) Filed: Apr. 29, 2002

Related U.S. Application Data
(63) Continuation-in-part of application No. 09/725,301, filed on Nov. 29, 2000.
(63) Continuation-in-part of application No. 09/725,883, filed on Mar. 9, 2001.

(51) Int. Cl. G09G 5/00

(52) U.S. Cl. 345/179

(57) ABSTRACT

The present invention proposes the use of a surface or writing surface such as paper and a moveable element such as a pen or a stylus. The stylus comprises an input means such as a charge-coupled device (CCD) or digital camera, a microcomputer, memory, power supply, and a communications device, whereby the digital camera scans the surface for position-related information to determine the position and/or movement of the stylus relative to the surface. The path of stylus is determined by detecting a sequence of position-related information. An output signal from the digital camera or array of light sensitive elements is sent to a computer or processor and finally output to the user. The output can be in various forms including an image on a computer display or a computer printout. When writing on the surface, handwriting recognition software can be used to convert the handwritten text into a “keyboard-typed” representation.

### FIELD OF THE INVENTION

This application is a continuation in part and claims the benefit under 35 USC 120 of U.S. patent application Ser. No. 09/725,301 filed Nov. 29, 2000 and U.S. patent application Ser. No. 09/725,883 filed Mar. 9, 2001. Previous disclosure was made in Disclosure Document No. 492507 filed Apr. 5, 2001 and PCT Application No. PCT/USO1/44854 filed Nov. 29, 2001. This invention relates to an apparatus and method for generating position-related computer data by obtaining and outputting the instantaneous position and/or movement of a moveable element on a surface, such as might be used for determining the position and/or movement of a pen/pencil on paper. In addition, this invention will allow the user to input graphical information (e.g., images, drawings or handwriting) and simultaneously provide an original hard copy of the information.

### BACKGROUND-DESCRIPTION OF PRIOR ART

The following United State Patents are believed to be most closely related to the present invention:

U.S. Pat. Nos.:

| | | | | |
|---|---|---|---|---|
| 6,100,538 | 6,008,800 | 6,005,548 | 5,982,352 | 5,953,000 |
| 5,936,615 | 5,729,251 | 5,689,619 | 5,525,764 | 5,477,012 |
| 5,442,147 | 5,086,197 | 5,075,558 | 5,075,541 | 5,051,736 |
| 5,009,277 | 4,975,546 | 4,885,433 | 4,853,496 | 4,845,684 |
| 4,809,351 | 4,806,707 | 4,804,949 | 4,751,741 | 4,532,376 |
| 4,364,035 | 4,141,073 | | | |

Many attempts have been made to determine the position of an object on a data surface in the form of computer data. Both two-dimensional and three-dimensional position determining devices now exist for inputting graphical data such as handwritten text, symbols, drawings, and so on. These devices determine the absolute position and/or movement of a stylus on a data surface by converting the position information into coordinates.

The use of a writing tablet and a stylus is common for inputting hand written data. Most two-dimensional devices require contact between the writing tablet and stylus. Three-dimensional devices usually do not require contact. They normally use a form of wave energy such as light, electromagnetic, or sonic energy.

Generally, two relationships exist between the stylus and the writing tablet. The passive stylus/active tablet utilizes a passive stylus interfacing with an active receiving surface (e.g., resistive and capacitive methods), while the active stylus/passive tablet utilizes an active stylus interfacing with a passive surface (e.g., optical, acoustic, tactile, or electromagnetic). A third method using a mechanical linkage such as a pantograph is rarely used.

The passive stylus/active surface method has some significant shortcomings. The most significant is the active surface or tablet itself Besides being complex, large, heavy, cumbersome, and difficult to transport, the tablet is expensive. Further, the tablet cannot usually distinguish between the stylus and another object pressing on it. Still further, active tablets are difficult to manufacture, subject to interference from outside factors, and have complex mechanical and electrical parts that are subject to malfunction.

The active stylus/passive surface method also has major drawbacks. Most significantly, this method generally requires an awkward tablet besides a separate transmitter and receiver (usually in different locations). Further, the transmitted signal can become obscured before reaching the receiver.

Another class of active stylus/passive surface devices provides relative position information. An example is the computer mouse that includes the mechanical mouse comprising a ball rolling on a surface, and the optical mouse comprising a surface with grid lines and an optical input means within the mouse.

Additionally, active stylus/passive surface methods comprise a form of transducer, gyroscope and/or accelerometer located in the stylus itself.

Both the passive stylus/active surface and active stylus/passive surface methods have the feeling of being unnatural and require a significant interface adjustment for the user from the conventional pen/pencil and paper. The amount and accuracy of information provided by these methods are limited. In addition, some of these methods require a physical connection between the stylus and the tablet. All the methods provide two-dimensional information. Some provide three-dimensional information. Further, they may provide one or more, but not all the following information: displacement, rotation, angle to tablet, and velocity. None provide all of this information.

The aforementioned methods can provide a printed hard copy, but they do not provide an original hard copy. Since the present invention teaches obtaining coordinate information by scanning a surface and simultaneously placing information on the surface by writing on the surface with a stylus, an original hard copy is produced by writing or drawing on the surface.

A significant advantage of the present invention is its interface. Overall, no matter how good a computer interface is, less of it would be better. The present invention allows for an interface that is almost identical to that of a pen/pencil and paper. The present invention is used in the same manner as a pen/pencil and paper and all of the computing is done in the background unnoticed by the user. The pen/pencil and paper are familiar and comfortable interfaces to the user.

This inventor has patented a device (U.S. Pat. Nos. 5,477,012 and 5,852,434) comprising a passive coded surface and an active stylus comprising a video camera. The drawback to this system is the requirement of the passive coded surface. Availability of the passive coded surface and the ability of the active stylus to accurately read the passive coded surface are only some of the disadvantages of the patented device. The present invention overcomes these drawbacks by eliminating the need for the passive coded surface. Now, any surface can be used. For example, stylus and paper in the present invention will most closely simulate the familiar use of ordinary pen/pencil and paper.

### OBJECTS AND ADVANTAGES

It is an object of the present invention to provide all of the aforementioned information.

It is an object of the present invention to overcome all of the aforementioned disadvantages.

It is an object of the present invention to provide an apparatus and method for obtaining and outputting the absolute position and/or movement of a moveable element on a surface.

It is an object of the present invention to provide an apparatus and method for obtaining and outputting the absolute position and/or movement of a moveable element on a surface for acquisition and output of hand written data.

It is an object of the present invention to provide a system that most closely resembles using pen/pencil and paper.

It is an object of the present invention to provide an original hard copy of data as part of the process of writing on a surface.

It is an object of the present invention to provide an apparatus and method of the character described in which the absolute position and/or movement of the movable element could be precisely determined relative to at least one fixed reference.

It is an object of the present invention to provide an apparatus and method of the character described in which the absolute position and/or movement of the movable element can be precisely determined relative to at least one fixed reference where the at least one fixed reference is automatically detected.

It is an object of the present invention to provide an apparatus for hand held use.

It is an object of the present invention to provide the aforementioned movable element in the shape of a stylus.

It is an object of the present invention to provide an apparatus of the character described which does not require the use of a special digitizing tablet.

It is an object of the present invention to provide an apparatus of the character described which does not require the use of a special surface.

It is an object of the present invention to provide an apparatus of the character described which does not require the use of a special transmitter.

It is an object of the present invention to provide an apparatus of the character described which could use a surface such as ordinary paper.

It is an object of the present invention to provide an apparatus and method for obtaining and outputting the position and/or movement of a moveable element on a surface comprising the surface, a detector means, a processing means and a output means.

It is an object of the present invention to provide an apparatus and method for precisely locating the absolute position and/or movement of a movable element within a plane. More particularly, it is an object of the invention to provide an input/output apparatus for use with a computer that includes a movable element, whose absolute position and/or movement within a plane can be determined with or without a physical connection between the movable element and the plane.

It is an object of the present invention to provide an apparatus and method for handwriting recognition.

It is an object of the present invention to provide an apparatus and method for optical character recognition (OCR).

It is an object of the present invention to provide an apparatus and method for signature verification.

It is an object of the present invention to provide an apparatus and method for handwriting verification.

It is an object of the present invention to provide an apparatus and method for graphical recognition.

It is an object of the present invention to provide an apparatus and method for graphical input.

It is an object of the present invention to provide an apparatus and method for image input.

It is an object of the present invention to provide an apparatus and method for forms processing.

It is an object of the present invention to provide an apparatus and method for converting optically input data into coordinate data.

It is an object of the present invention to provide an apparatus and method for applying position-related information to a surface.

It is an object of the present invention to provide an apparatus and method for applying position-related information to a surface with by writing on it while scanning, then using the written information for position determination.

It is an object of the present invention to provide an apparatus and method for applying position-related information to a surface by writing the surface while scanning, then using the written data as points of reference.

It is an object of the present invention to provide an apparatus and method for precisely locating the absolute position and/or movement of a movable element within a plane using well-known techniques of interpolation, extrapolation, and triangulation.

It is an object of the present invention to provide an apparatus and method for precisely locating the absolute position and/or movement of a movable element within a plane using well known techniques of pattern matching, sliding window correlation, and windowing.

It is an object of the present invention to provide an apparatus and method for precisely locating the absolute position and/or movement of a movable element within a plane using well-known techniques of pattern recognition and partial imaging.

It is an object of the present invention to provide an apparatus and method for providing analog data.

It is an object of the present invention to provide an apparatus and method for providing digital data.

It is an object of the present invention to provide an apparatus and method for digitizing optical data.

It is an object of the present invention to provide an apparatus and method for learning a surface.

It is an object of the present invention to provide a surface made of a material selected from the group consisting of paper, plastic, glass, metal, synthetic fiber, synthetic material, natural material, and a paper like substance.

It is an object of the present invention to provide an apparatus and method for use as a video camera, still camera and/or Internet camera.

It is an object of the present invention to provide an apparatus and method for use as a cell phone.

It is an object of the present invention to provide an apparatus and method for use as a cell phone, video camera, still camera and/or Internet camera whereby the mouthpiece functions as the microphone, the earpiece functions as the speaker and the display functions as the camera display.

It is an object of the present invention to provide an apparatus and method for use as an optical computer mouse.

It is an object of the present invention to provide an apparatus and method for use as an “ink-well” like interface designed to provide communication with other devices using means including optical, wireless and/or electronic.

It is an object of the present invention to provide an apparatus and method using mirrors mounted at angles to detect the position of the writing element using triangulation, pattern-matching and/or position-related code.

It is an object of the present invention to provide an apparatus and method using split-screen and/or two digital cameras to capture different views of the surface and the frames of the two digital cameras calibrated and compared with each other to determine movement and position of the writing element.

It is an object of the present invention to provide an apparatus and method using grid and moiré triangulation.

It is an object of the present invention to provide an apparatus and method using an overlay such as carbon paper, film template or plate for overlaying the surface with position-related data, a pressure switch for turning on the lower digital camera when pressure is applied to the writing element and a focusing method for focusing the surface.

### DESCRIPTION OF DRAWINGS

FIG. 1 is a perspective view of a surface, a pen comprising a removable digital camera, a computer and wireless interface.

FIGS. 2,3 are perspective views of a surface, a pen comprising two fixed digital cameras in different orientations and wireless interface.

FIGS. 4-6 are perspective views of a surface, a pen comprising one fixed digital camera in different orientations and wireless interface.

FIGS. 7-10 are side views of a stylus/cell phone (Pencell™) in different orientations.

FIG. 11 is an example of successive images acquired from writing on a surface.

FIG. 12 is an example of a method to orient two images.

### REFERENCE NUMERALS IN DRAWINGS

| | | | |
|---|---|---|---|
| 1 | surface | 2 | stylus |
| 3a | upper digital camera | 3b | lower digital camera |
| 4 | wireless interface | 5a | left corner |
| 5b | right corner | 6a | writing element |
| 6b | lower sensor | 7 | adapter |
| 8 | universal joint | 9 | computer |
| 10 | clipboard | 11a | left clipboard reference |
| | | | point |
| 11b | right clipboard reference point | 12a | left external reference point |
| 12b | right external reference point | 13 | microcomputer |
| 14 | display | 15 | function keys |
| 16 | illumination | 17 | visual field |
| 18 | cell phone | 19 | mouth piece |
| 20 | ear piece | 21 | display |
| 22 | function keys | 23 | pen |
| 24 | pen retractor | 25 | keypad |
| 26 | memory | 27 | microcomputer |
| 28 | power supply | 29 | marks |
| 30 | images | 31 | line |

### DESCRIPTION OF PREFERRED EMBODIMENTS

The present invention aims to overcome the aforementioned disadvantages and to provide a system that most closely emulates the use of pen/pencil and paper.

Accordingly, the present invention proposes the use of a surface or writing surface such as paper and a moveable element such as a pen or stylus. The stylus comprises an input means such as a charge-coupled device (CCD) or digital camera, a microcomputer, memory, power supply, and a communications device, whereby the digital camera scans the surface for position-related information to determine the position and/or movement of the stylus relative to the surface. The path of stylus is determined by detecting a sequence of position-related information. An output signal from the digital camera or array of light sensitive elements is sent to a computer or processor and finally output to the user. The output can be in various forms including an image on a computer display or a computer printout. When writing on the surface, handwriting recognition software can be used to convert the handwritten text into a “keyboard-typed” representation.

The three methods used independently and/or together to determine position and movement of a stylus on paper are triangulation, pattern-matching and position-related code. The position-related code method is described in this inventor's U.S. Pat. No. 5,477,012 (Optical Position Determination) and U.S. Pat. No. 5,852,434 (Absolute Optical Position Determination). For the most part, triangulation and pattern-matching are limited to the visual field of the digital camera, while the position-related code method can reference positions outside the visual field. The pattern-matching method can scan and compile images to form a picture of the surface without reference to the stylus, while triangulation can use the writing element on the stylus as the third point or movable point of reference. In some cases, triangulation and pattern-matching methods may overlap, such as when at least three points to be triangulated are on the surface. Both triangulation and pattern-matching need not reference the parameters of the surface or the surface outside the visual field. When scanning patterns from a surface, the patterns can be repetitive or variant. Repetitive patterns are made unique when a writing element on the stylus is used to form marks on the repetitive pattern. The relationship of the mark formed to the repetitive pattern will be unique and will distinguish that repetitive pattern from others

These terms are used in their broadest sense and include methods that are more specific. For example, triangulation may include specific methods such as optical techniques of grid and moiré triangulation. In some cases, other mathematical techniques such as interpolation, extrapolation, smoothing, and other compensating techniques may be appropriately used. Pattern-matching may include sliding window correlation, windowing, pattern recognition, and partial imaging. For the purposes of this description, these various methods and others available to those skilled in the art are all incorporated.

Pattern-matching is used to pick-up and match patterns from a surface to form a larger picture of the surface and/or to determine the instantaneous position and movement of the writing element relative to a pattern on the surface. While writing on a surface, the pattern formed is instantaneously input by acquiring successive images of the surface as the writing element moves across the surface. Images are compiled into a picture of the surface being scanned by the digital camera. As writing is being placed on the surface, successive images of the writing are acquired and compiled. Earlier images are matched to successive images until the entire pattern on the surface is compiled into a larger picture. In this way, the position of patterns relative to each other, the position of patterns relative to the surface, and/or the instantaneous position and movement of the writing element relative to a pattern on the surface can be determined.

The images acquired can be existing images on the surface and/or can be the actual writing as it is being formed. When using pattern-matching without triangulation, acquired images should overlap to the degree that consecutive images can be referenced back to previous images to build a larger picture of the surface.

On the other hand, using the principal of triangulation, the instantaneous position and movement of the stylus relative to two fixed points is determined. This method is explained in more detail in this inventor's U.S. patent application Ser. No. 09/25,301 (Absolute Optical Position Determination) and Ser. No. 09/725,883 (Optical Position Determination on Plain Paper). The digital camera automatically detects at least two fixed points, such as the comers of the surface, and triangulates them with a third point on a writing element on the stylus to determine the instantaneous position of the writing element. Alternatively, fixed points visible to the digital camera can be applied to the surface using the writing element on the stylus. Still further, fixed points can be pre-applied or printed to the surface.

The two fixed points are dynamic, in that, the digital camera will select two-fixed reference points based on a set of pre-determined criteria. The two fixed points need only to be fixed instantaneously since the digital camera is able to dynamically and instantaneously select a different set of two fixed points.

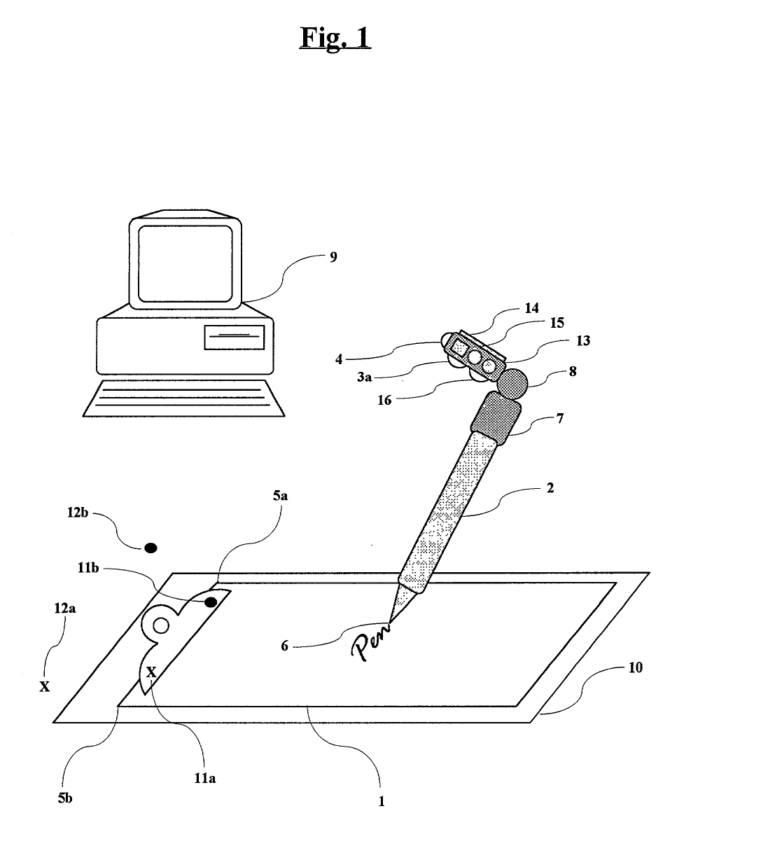

A first embodiment comprises a surface 1 in FIG. 1, a stylus 2, an upper digital camera 3a, and a wireless interface 4. The upper digital camera detects two fixed points based on a set of pre-determined criteria such as corners 5a and 5b of the surface and triangulates the instantaneous position of the writing element 6 of the pen. The two fixed points are dynamic, in that, the upper digital camera will detect any two points, which may include the corners of the surface, or any other points in its visual field. The other points may include pre-applied marks on the surface or marks instantly applied using the writing element. The upper digital camera may dynamically change the two fixed points it selects based on a set of pre-determined criteria.

The upper digital camera is mounted on the stylus 2 using an adapter 7 that fits securely on the upper end of the stylus. This position allows the upper digital camera to view the surface, the writing element, and the two fixed points. Should the reference points become obscured from the visual field, the upper digital camera will select other reference points. A universal joint 8 allows maximum mobility for the upper digital camera. Finally, position-related information is sent by a wireless means to a computer 9 for processing.

Further, a clip board 10 can be provided comprising the two fixed points, such as the left clip board reference point 11a and the right clip board reference point 11b. Still further, the two fixed points can be provided external to the surface or the clip board, such as the left external reference point 12a and the right external reference point 12b. A microprocessor 13 and a display 14 can be provided. Function keys 15 and an illumination means 16 can also be provided.

While writing on the surface, the two fixed points are detected relative to the writing element, input, and analyzed. Thus, the instantaneous position and movement of the writing element is determined. At least two points of coordinate-related information can be made to selectively reflect at least one selected frequency of light, and a detector means can be made to selectively detect at least one selected frequency of light.

For greater resolution and/or accuracy, both macro-triangulation and/or micro-triangulation techniques can be used to determine the instantaneous position and movement of the stylus relative to the writing. Macro triangulation detects larger areas to triangulate such as the corners of the surface and the writing element. Micro triangulation detects smaller areas to triangulate such as points of the written text or image on the surface. The general position such as the position and movement of the writing element relative to the surface is determined by macro-triangulation and the more exact position is determined by micro-triangulation.

Alternatively, pattern-matching can be used to compile images into a picture of the surface and/or the scanned images. Scanned images can be those already existing in the visual field of the upper digital camera, or they can be images being scanned as they are being formed by the writing element. Scanned images within the visual field of the upper digital camera do not necessarily have to be on the surface. Any images within the visual field can be scanned and compiled into a larger picture.

Still further, triangulation, pattern-matching and/or position-related code techniques can be used to determine the instantaneous position and/or movement of the stylus relative to the surface. Triangulation determines the instantaneous position and movement of the writing element. Pattern-matching inputs images such as the written text by acquiring successive images of the surface as the writing element moves across the surface and compiles the images into a picture of the surface scanned by the upper digital camera. The two techniques together give accurate and high-resolution data regarding the instantaneous position and movement of the writing element.

With the upper digital camera placed on the upper end of the stylus, the instantaneous written text may not be immediately visible to the upper digital camera because the writer's hand may block the upper digital camera's view. In this case, triangulation determines the instantaneous position and/or movement of the stylus since at least two fixed points, such as the corners of the surface, are visible to the upper digital camera and the third point or movable point on the writing element is known. At least three points are triangulated to determine the instantaneous position and/or movement of the writing element. As the stylus moves across the surface, the formerly blocked text will eventually come into view. At this point, pattern-matching is used to match this image with previous images to form an overall picture of the surface.

In addition to a composite static image of the scanned surface, other information such velocity, acceleration, rotation, and/or attitude of the stylus can be obtained.

Thus far, the above embodiments use a single upper digital camera mounted on the upper end of the stylus for a greater perspective of the surface. Other embodiments are possible such as a single lower digital camera or a second lower digital camera mounted on the lower end of the stylus.

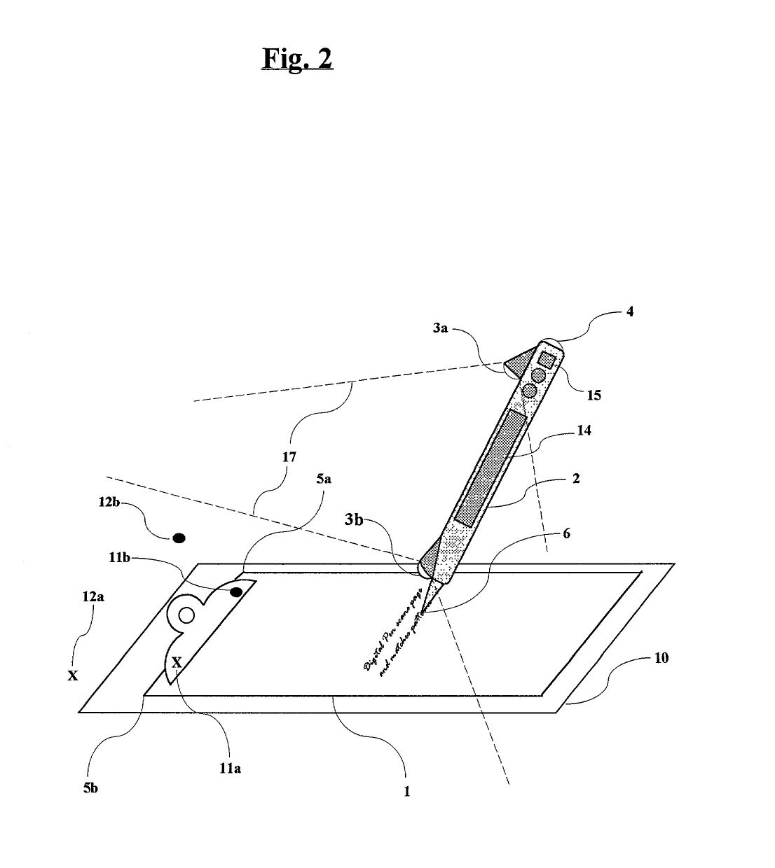

A second embodiment in FIG. 2 utilizes a second lower digital camera 3b mounted on the lower end of the stylus facing the same direction as the upper digital camera. The upper digital camera provides macro-triangulation, pattern-matching and/or position-related code and the lower digital camera provides micro-triangulation, pattern-matching and/or position-related code. The visual fields of the digital cameras are represented by 17 in FIG. 2.

A third embodiment in FIG. 3 comprises both the upper digital camera and lower digital camera mounted in opposite directions, whereby the upper digital camera uses macro-triangulation, pattern-matching and/or position-related code and the lower digital camera uses micro-triangulation, pattern-matching and/or position-related code. The visual fields of the digital cameras are represented by 17 in FIG. 3. These techniques combined provide high-resolution data regarding information on the surface and movement of the stylus over the surface.

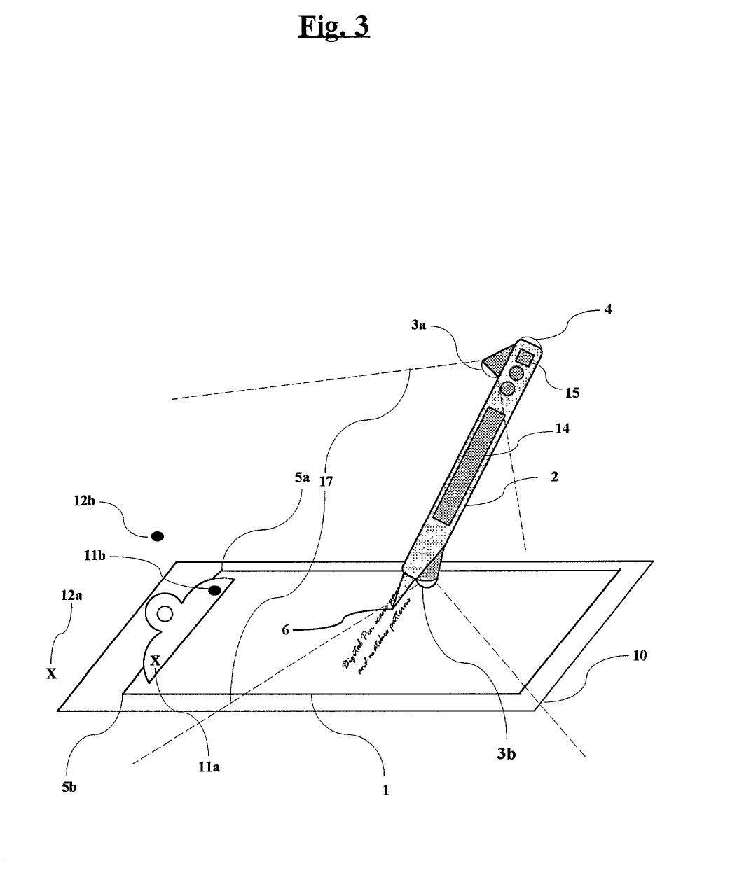

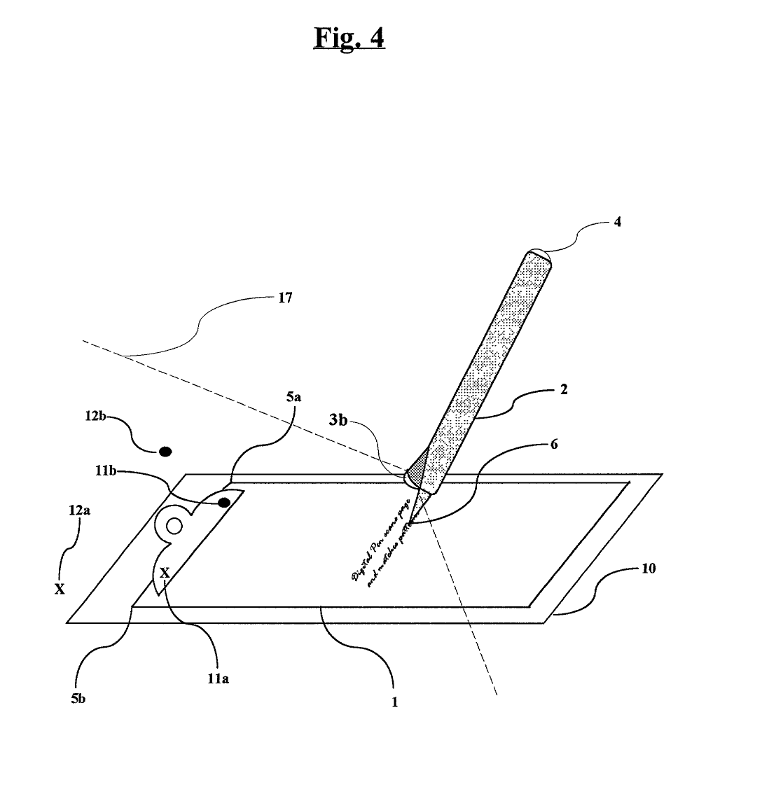

A fourth embodiment in FIG. 4 comprises a lower digital camera 3b mounted away from the user. A fifth embodiment in FIG. 5 comprises an upper digital camera 3a and a lower sensor 6b. The lower sensor can be in the form of a trackball, pressure sensor, transducer, gyroscope, and/or accelerometer located in the stylus itself, whereby the upper digital camera uses macro-triangulation, micro-triangulation, pattern-matching and/or position-related code, while the sensor provides movement information.

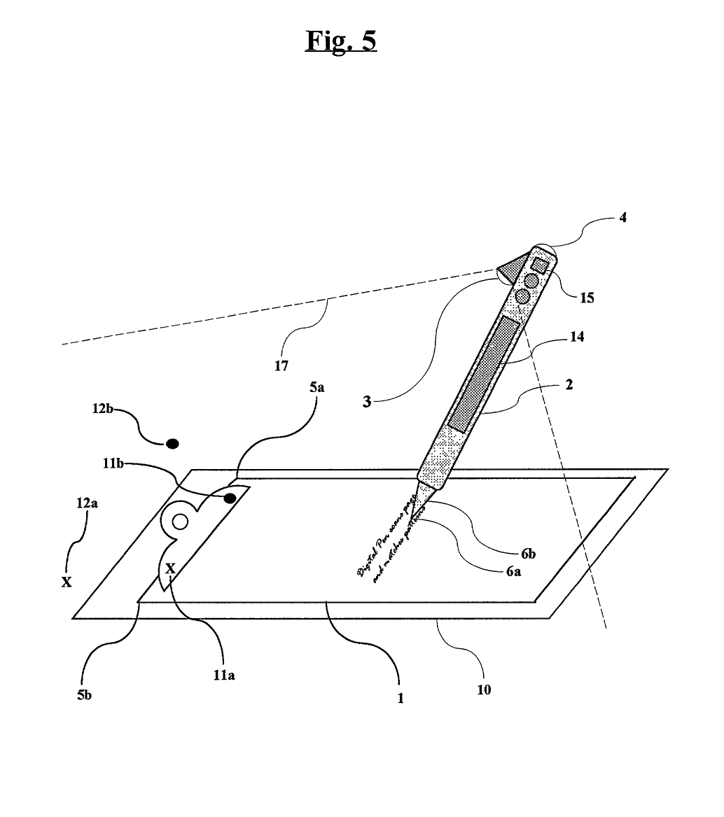

A sixth embodiment in FIG. 6 uses a lower digital camera 3b and a lower sensor 6b. The lower sensor can be in the form of a track ball, pressure sensor, transducer, gyroscope, and/or accelerometer located in the stylus itself, whereby the lower digital camera uses macro-triangulation, micro-triangulation, pattern-matching and/or position-related code, while the sensor provides relative position and movement information.

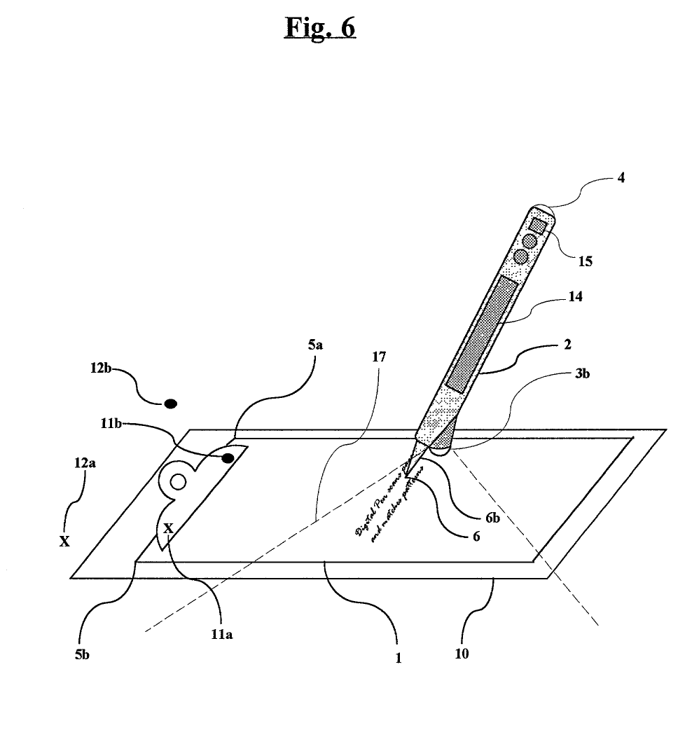

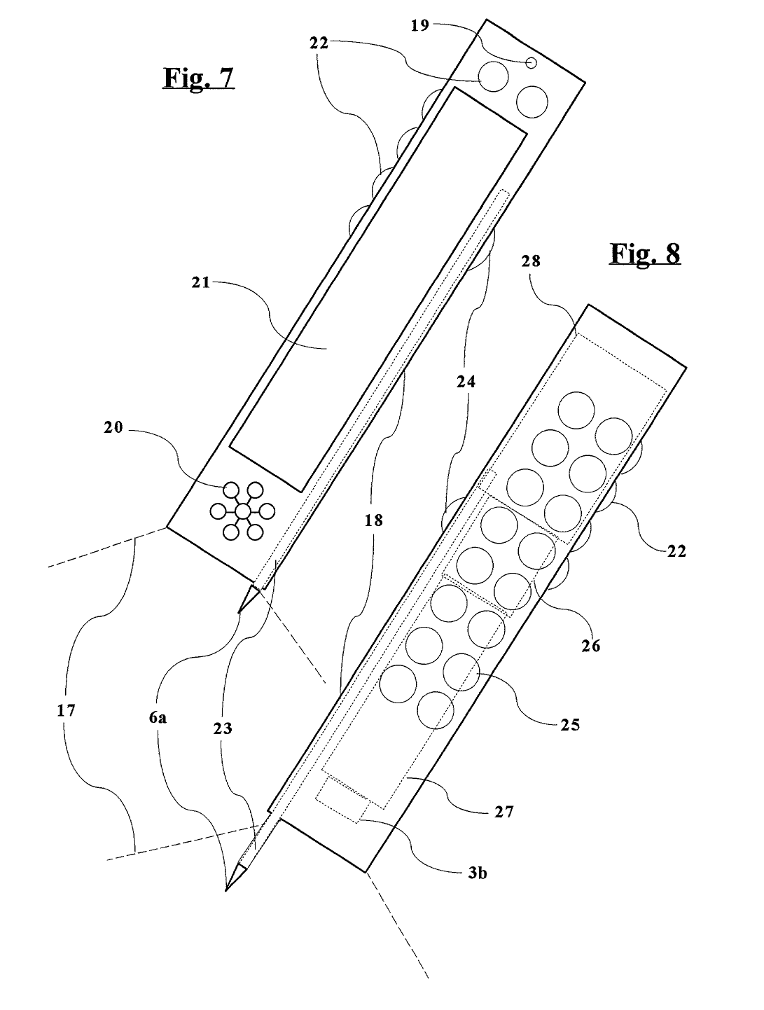

In a seventh embodiment, the stylus incorporates a cell phone 18 in FIG. 7 in the shape of a stylus to form a Pencell™ comprising a mouth piece 19, ear piece 20, display 21, function keys 22, pen 23, pen retractor 24, keypad 25, lower digital camera 3b, memory 26, micro computer 27, power supply 28 and writing element 6a. The display is on one side of the Pencell™ FIG. 7 and the keypad is on the other side FIG. 8.

The pen is retractable to hide the writing element when not in use. The pen is extended only slightly when the writing element is closer to the user FIG. 7. When the writing element is further away from the user, the pen is extended further FIG. 8. The pen retractor is used to move the pen in and out of the cell phone.

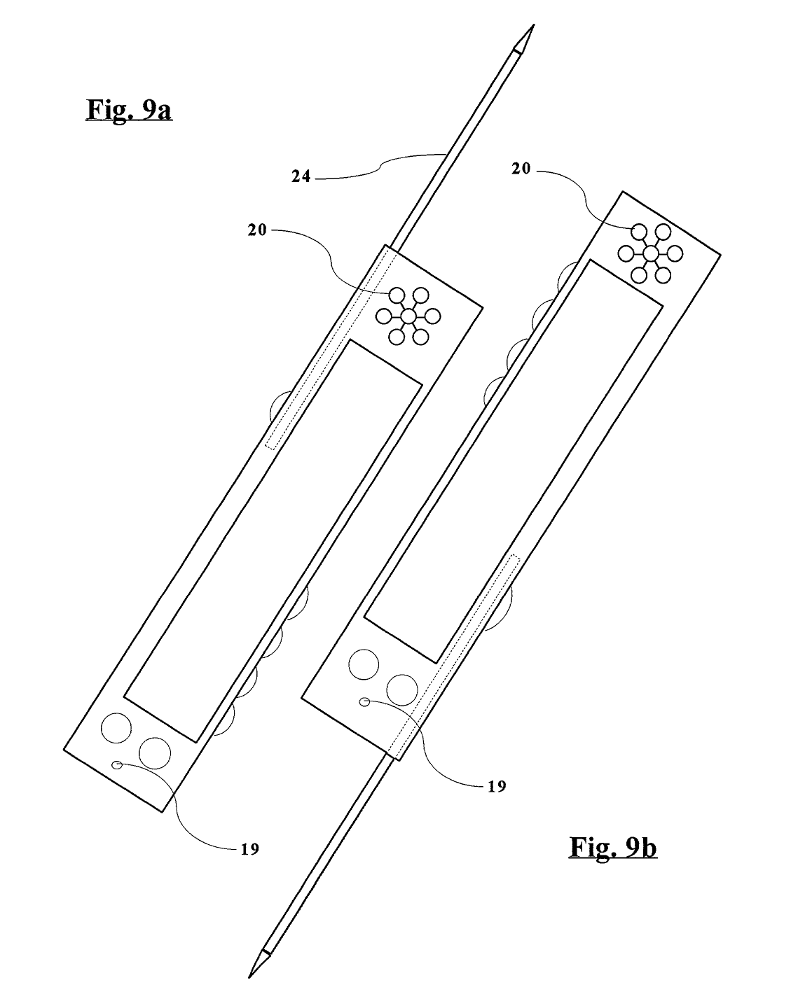

When used as a cell phone FIG. 9a, the pen doubles as an antenna. The Pencell™ is flipped so that the pen is extended up to act as an antenna. This puts the earpiece and mouthpiece in position for use. In another embodiment, the positions of earpiece and mouthpiece can be reversed so that the pen is extended down to act as an antenna FIG. 9b. Harmful cell phone radiation can be directed away from the head. In this case, the Pencell™ does not have to be flipped to use the cell phone.

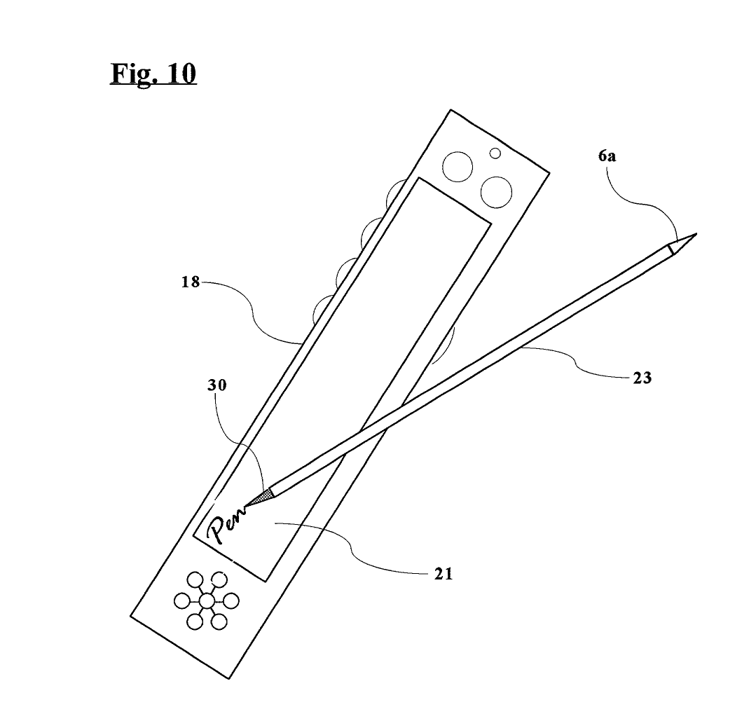

Further, the pen can be completely removable to write on the display 21 FIG. 10. In this case, the pen will have two writing ends, one comprising the writing element 6 and the other comprising the writing tip 29. The writing tip is designed to write on the display while the writing element is intended to write on a surface. The writing tip fits into the Pencell™ first to allow the writing element to be extended for writing on a surface.

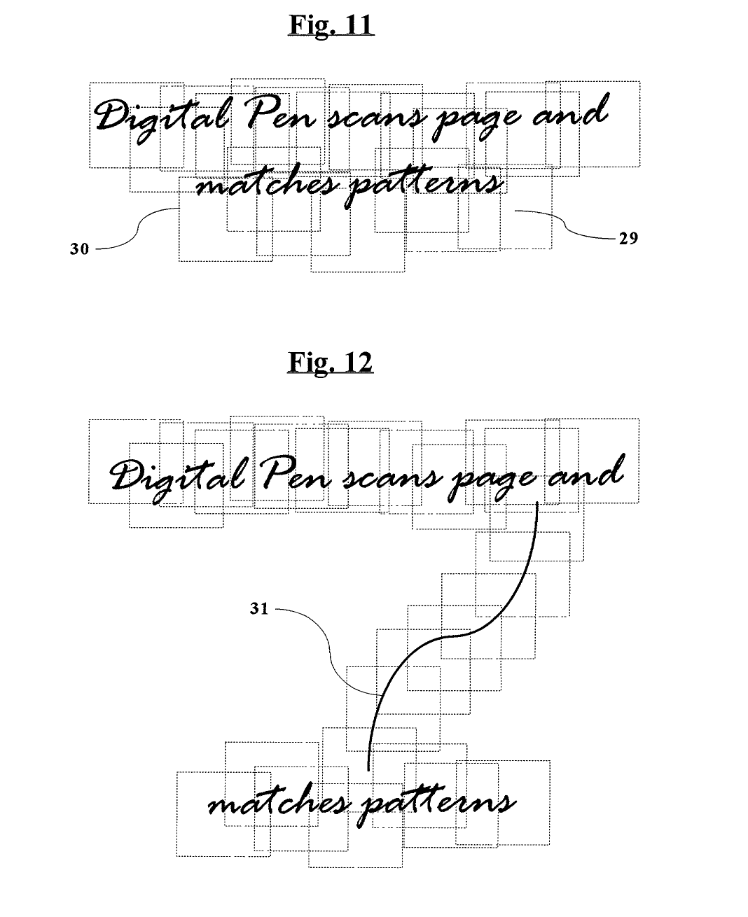

In an eighth embodiment FIG. 11, pattern-matching is used to determine the instantaneous position and movement of the writing element relative to a pattern on a surface. While writing on a surface, the marks 29 formed are instantaneously input by acquiring successive images 30 of the surface as the writing element moves across the surface. Images are scanned by the digital camera and compiled into a picture of the surface. As writing is being placed on the surface, successive images are acquired and compiled. Earlier images are matched to successive images until the text on the surface is compiled into a larger picture.

In all embodiments, images acquired can be existing images on a surface or can be the actual marks as they are being formed by the writing element. Triangulation, pattern-matching and position-related code can be used independently, together or alternately. When using pattern-matching without triangulation or position-related code, acquired images should overlap to the degree that consecutive images can be referenced back to previous images to build a larger picture of the surface. Surfaces can be rescanned for accuracy.

Images that do not overlap can be oriented to each other by scanning the area between them to connect the images for determining their positions relative to each other. For example, a line 31 in FIG. 12 drawn between two images can orient the images relative to each other. When drawing the line using the writing element, an “ignore” function on the stylus can be used to ignore the line, except for the purpose of orientation. When the writing tip is extended, no line is drawn on the surface. A virtual line can be traced by triangulating and/or pattern-matching other reference points and/or images on the surface, and/or by position-related code.

In other embodiments, additional functionality is added such as enabling the upper digital camera and/or lower digital camera to be used as a video camera, still camera and/or internet camera. The cell phone embodiment can function as a portable video camera whereby the mouthpiece functions as the microphone, the earpiece functions as the speaker and the display functions as the camera display. The camera display can be designed to flip open and twist for viewing and exposing the camera display and function keys similar to many presently available portable video cameras. Additionally, the cell phone 18 can be designed to flip open for viewing and exposing the display and function keys.

Further embodiments include an overlay such as carbon paper, film template or plate for overlaying the surface with position-related data, a pressure switch for turning on the lower digital camera when pressure is applied to the writing element and a focusing method for focusing the surface. Still further, the lower digital camera can function as an optical computer mouse. An “ink-well” like interface can be designed to provide communication with other devices using means including optical, wireless and/or electronic.

Other techniques could be used to determine the position of the writing element. For example, mirrors mounted at angles to detect the position of the writing element using triangulation, pattern-matching and/or position-related code. Additionally, split-screen and/or two digital cameras can be used to capture different views of the surface and the frames of the two digital cameras can be calibrated and compared with each other to determine movement and position of the writing element. Other optical techniques are grid and moiré triangulation.

The above-described embodiments are simply illustrative of the principles of the invention. Various other modifications and changes may be made by those skilled in the art which will embody the principles of the invention and fall within the spirit and scope thereof.

I claim:

1. An apparatus for obtaining and outputting the position and movement of a moveable element on a surface comprising
a. a position-related means for designating position information,
b. an input means for acquiring position information from said position-related means,
c. an output means for outputting position information, and
d. a processing means for obtaining and analyzing position information from said output means.

2. An apparatus according to claim 1 whereby
a. said position-related means comprises at least three points,
b. said at least three points comprising at least two fixed points and at least one movable point,
c. said movable element comprises said at least one movable point, and
d. comprises triangulating means for determining the position and movement of said moveable element.

3. An apparatus according to claim 1 whereby
a. said position-related means comprises at least one pattern, and
b. comprises pattern-matching means for determining the position and movement of said moveable element.

4. An apparatus according to claim 1 whereby said position-related means comprises position-related code means designating two dimensional coordinates of at least one point for determining the position and movement of said moveable element.

5. An apparatus according to claim 1 comprising means for determining the position and movement of said moveable element selected from the group consisting of
a. triangulating means,
b. pattern-matching means,
c. position-related code means, and
d. any combination thereof.

6. An apparatus according to claim 1 comprising a cell phone selected from the group consisting of
a. said cell phone comprising a mouth piece, an ear piece, a display, function keys, a pen, a pen retractor, a keypad, a lower digital camera, memory, a micro computer, power supply and a writing element;
b. said cell phone comprising a mouth piece, an ear piece, a display, function keys, a pen, a pen retractor, a keypad, a lower digital camera, memory, a micro computer, power supply, a writing element, and a lower sensor selected from the group consisting of a track ball, pressure sensor, transducer, gyroscope, and an accelerometer;
c. said cell phone comprising a portable video camera further comprising a mouthpiece that functions as a microphone, an earpiece that functions as a speaker and a display that functions as a camera display;
d. said cell phone comprising a portable video camera further comprising a mouthpiece that functions as a microphone, an earpiece that functions as a speaker and a display that functions as a camera display whereby the camera display flips open and twists for viewing and exposing function keys;
e. said cell phone whereby said cell phone flips open for viewing and exposing function keys and a display;
f. said cell phone in the shape of a stylus; and
g. said cell phone for hand held use.

7. An apparatus according to claim 1 selected from the group consisting of
a. said surface comprising a writing surface;
b. said movable element comprising a writing means for writing on said surface;
c. said surface comprising a substantially two dimensional planar face;
d. said input means is a detector means comprising an array of light sensitive elements for detecting said position-related means and said output means for generating at least one output signal thereof,
e. said processing means comprising means for receiving and processing said at least one output signal form said input means, thereby to determine the position and movement of said movable element relative to said surface;
f. said moveable element comprising said input means, whereby said movable element is movable relative to said surface;
g. means for determining the path of said moveable element by detecting said position-related means;
h. means for determining the path of said moveable element by detecting a sequence of said position-related means;
i. means for analyzing the path of said moveable element;
j. said position-related means comprising position-related data;
k. said position-related means is printed on said surface;
l. said position-related means is written on said surface;
m. said position-related means comprising existing features on said surface;
n. said position-related means comprising existing features obtainable by said input means;
o. at least part of said position-related means is outside said surface;
p. said surface comprising a writing surface and said movable element comprising a writing means for writing on said surface and whereby said writing means comprises said at least part of said position-related means;
q. said apparatus intended for use with a computer;
r. said apparatus comprising a computer display;
s. said apparatus comprising a computer printer;
t. said apparatus comprising a computer;
u. said apparatus comprising a digital camera;
v. said apparatus comprising writing means for writing on said surface;
w. said apparatus comprising a microcomputer;
x. said apparatus comprising a display;
y. said apparatus comprising function keys;
z. said apparatus comprising an illumination means;
aa. said processing means comprising a computer;
bb. said apparatus comprising a writing means for writing on said surface and further comprising an original hard copy means for forming an original hard copy made by said writing means on said surface;
cc. said surface made of a material selected from the group consisting of paper, plastic, glass, metal, synthetic fiber, synthetic material, natural material, and a paper like substance;
dd. said position-related means comprising a reflecting means for reflecting said position-related means to said input means;
ee. said moveable element selected from the group consisting of a stylus shaped moveable element for hand held use, a hand held moveable element, a cell phone and a stylus shaped cell phone;
ff. said surface comprising an overlay means for overlaying said surface with said position-related means;
gg. said surface comprising an overlay means for overlaying said surface with said position-related means selected from the group consisting of carbon paper, film, template, plate and sheet;
hh. said position-related means comprising a selective reflecting means for selectively reflecting at least one selected frequency of light;
ii. said input means comprising a selective input means for selectively inputting at least one selected frequency of light;
jj. said input means comprising a selective input means for selectively inputting said position-related means;
kk. said apparatus comprising a pressure switch means for turning on said apparatus when pressure is applied to said movable element;
ll. said apparatus comprising a focusing means for focusing said surface;
mm. said movable element comprising a writing means for writing on said surface;
nn. said movable element comprising a self contained optical stylus, a writing means for writing on said surface, a microcomputer, a user interface means for communicating with a user and a device interface means for communicating with other devices;
oo. said input means selected from the group consisting of said input means mounted on said movable element; said input means mounted on a computer monitor, said input means mounted on a portable computer, said input means mounted to input said position-related means;
pp. said input means selected from the group consisting of an upper input means, a lower input means, an upper input means and a lower input means mounted in the same direction, an upper input means and a lower input means mounted in opposite directions;
qq. said apparatus further comprising an element selected from the group consisting of a track ball, a pressure sensor, a transducer, a gyroscope, and an accelerometer;
rr. said apparatus comprising a cell phone in the shape of a stylus further comprising a mouth piece, an ear piece, a display, function keys, a pen, a pen retractor, a keypad, a digital camera, memory, a micro computer, power supply, and a writing element;
ss. said processing means adapted to produce a digital duplicate of visible marks made on said surface,
tt. said apparatus comprising macro-triangulating means and micro-triangulating means for determining the position and movement of said moveable element;
uu. said apparatus comprising handwriting recognition means for converting handwritten text into a “keyboard-typed” representation;
vv. said surface comprising a repetitive pattern that is made unique by marking said repetitive pattern with said movable element comprising a writing element;
ww. said input means comprising an upper digital camera selected from the group consisting of a video camera, a still camera, video conferencing camera and an internet camera;
xx. said input means comprising a lower digital camera selected from the group consisting of a video camera, a still camera, video conferencing camera and an internet camera;
yy. said input means comprising a lower digital camera that can function as an optical computer mouse;
zz. said apparatus comprising an “ink-well” like interface for said output means to communicate with other devices using means selected form the group consisting of optical means, wireless means and electronic means;
aaa. said input means comprising a digital camera and further comprising mirrors mounted at angles to detect the position of said movable element using triangulation, pattern-matching and/or position-related code;
bbb. said input means comprising a digital camera and further comprising a split-screen to capture different views of said surface whereby said different views are calibrated and compared with each other to determine movement and position of the writing element;
ccc. said apparatus comprising two digital cameras to capture different views of the surface whereby the frames of said two digital cameras are calibrated and compared with each other to determine movement and position of said movable element.

8. A device for producing an electronic duplicate of markings made upon a surface comprising
a. a position-related means for designating position information,
b. a movable element,
c. a detector means for detecting said position-related means and for generating at least one output signal thereof, and
d. a processing means for receiving and processing said at least one output signal, thereby to determine the position of said movable element relative to said surface.

9. A device according to claim 8 whereby
a. said position-related means comprises at least three points,
b. said at least three points comprise least two fixed points and at least one movable point,
c. said movable element comprises said at least one movable point, and
d. said device further comprises triangulating means for determining the position and movement of said moveable element.

10. A device according to claim 8 whereby
c. said position-related means comprises at least one pattern, and
d. said device further comprises pattern-matching means for determining the position and movement of said moveable element.

11. A device according to claim 8 whereby said position-related means comprises position-related code means designating two dimensional coordinates of at least one point for determining the position and movement of said moveable element.

12. A device according to claim 8 comprising means for determining the position and movement of said moveable element selected from the group consisting of
e. triangulating means,
f. pattern-matching means,
g. position-related code means, and
h. any combination thereof.

13. A device according to claim 8 comprising a cell phone selected from the group consisting of
a. said cell phone comprising a mouth piece, an ear piece, a display, function keys, a pen, a pen retractor, a keypad, a lower digital camera, memory, a micro computer, power supply and a writing element;
b. said cell phone comprising a mouth piece, an ear piece, a display, function keys, a pen, a pen retractor, a keypad, a lower digital camera, memory, a micro computer, power supply, a writing element, and a lower sensor selected from the group consisting of a track ball, pressure sensor, transducer, gyroscope, and an accelerometer;
c. said cell phone comprising a portable video camera further comprising a mouthpiece that functions as a microphone, an earpiece that functions as a speaker and a display that functions as a camera display;
d. said cell phone comprising a portable video camera further comprising a mouthpiece that functions as a microphone, an earpiece that functions as a speaker and a display that functions as a camera display whereby the camera display flips open and twists for viewing and exposing function keys;
e. said cell phone whereby said cell phone flips open for viewing and exposing function keys and a display;
f. said cell phone in the shape of a stylus; and
g. said cell phone for hand held use.

14. A device according to claim 8 selected from the group consisting of
a. said surface comprising a writing surface;
b. said movable element comprising a writing means for writing on said surface;
c. said surface comprising a substantially two dimensional planar face;
d. said detector means comprises an array of light sensitive elements for detecting said position-related means and for generating said at least one output signal thereof;
e. said processing means comprising means for receiving and processing said at least one output signal form said detector means, thereby to determine the position and movement of said movable element relative to said surface;
f. said moveable element comprising said detector means, whereby said movable element is movable relative to said surface;
g. means for determining the path of said moveable element by detecting said position-related means;
h. means for determining the path of said moveable element by detecting a sequence of said position-related means;
i. means for analyzing the path of said moveable element;
j. said position-related means comprising position-related data;
k. said position-related means is printed on said surface;
l. said position-related means is written on said surface;
m. said position-related means comprising existing features on said surface;
n. said position-related means comprising existing features obtainable by said detector means;
O. at least part of said position-related means is outside said surface;
p. said surface comprising a writing surface and said movable element comprising a writing means for writing on said surface and whereby said writing means comprises said at least part of said position-related means;
q. said apparatus intended for use with a computer;
r. said apparatus comprising a computer display;
s. said apparatus comprising a computer printer;
t. said apparatus comprising a computer;
u. said apparatus comprising a digital camera;
v. said apparatus comprising writing means for writing on said surface;
w. said apparatus comprising a microcomputer;
x. said apparatus comprising a display;
y. said apparatus comprising function keys;
z. said apparatus comprising an illumination means;
aa. said processing means comprising a computer;
bb. said apparatus comprising a writing means for writing on said surface and further comprising an original hard copy means for forming an original hard copy made by said writing means on said surface;
cc. said surface made of a material selected from the group consisting of paper, plastic, glass, metal, synthetic fiber, synthetic material, natural material, and a paper like substance;
dd. said position-related means comprising a reflecting means for reflecting said position-related means to said detector means;
ee. said moveable element selected from the group consisting of a stylus shaped moveable element for hand held use, a hand held moveable element, a cell phone and a stylus shaped cell phone;
ff. said surface comprising an overlay means for overlaying said surface with said position-related means;
gg. said surface comprising an overlay means for overlaying said surface with said position-related means selected from the group consisting of carbon paper, film, template, plate and sheet;
hh. said position-related means comprising a selective reflecting means for selectively reflecting at least one selected frequency of light;
ii. said detector means comprising a selective detecting means for selectively detecting at least one selected frequency of light;
jj. said detector means comprising a selective detecting means for selectively detecting said position-related means;
kk. said apparatus comprising a pressure switch means for turning on said apparatus when pressure is applied to said movable element;
ll. said apparatus comprising a focusing means for focusing said surface;
mm. said movable element comprising a writing means for writing on said surface;
nn. said movable element comprising a self contained optical stylus, a writing means for writing on said surface, a microcomputer, a user interface means for communicating with a user and a device interface means for communicating with other devices;
oo. said detector means selected from the group consisting of said detector means mounted on said movable element; said detector means mounted on a computer monitor, said detector means mounted on a portable computer, said detector means mounted to detect said position-related means;
pp. said detector means selected from the group consisting of an upper detector means, a lower detector means, an upper detector means and a lower detector means mounted in the same direction, an upper detector means and a lower detector means mounted in opposite directions;
qq. said apparatus further comprising an element selected from the group consisting of a track ball, a pressure sensor, a transducer, a gyroscope, and an accelerometer;
rr. said apparatus comprising a cell phone in the shape of a stylus further comprising a mouth piece, an ear piece, a display, function keys, a pen, a pen retractor, a keypad, a digital camera, memory, a micro computer, power supply, and a writing element;
ss. said processing means adapted to produce a digital duplicate of visible marks made on said surface,
tt. said apparatus comprising macro-triangulating means and micro-triangulating means for determining the position and movement of said moveable element;
uu. said apparatus comprising handwriting recognition means for converting handwritten text into a “keyboard-typed” representation;
vv. said surface comprising a repetitive pattern that is made unique by marking said repetitive pattern with said movable element comprising a writing element;
ww. said detector means comprising an upper digital camera selected from the group consisting of a video camera, a still camera, video conferencing camera and an internet camera;
xx. said detector means comprising a lower digital camera selected from the group consisting of a video camera, a still camera, video conferencing camera and an internet camera;
yy. said detector means comprising a lower digital camera that can function as an optical computer mouse;
zz. said apparatus comprising an “ink-well” like interface for said detector means to communicate with other devices using means selected form the group consisting of optical means, wireless means and electronic means;
aaa. said detector means comprising a digital camera and further comprising mirrors mounted at angles to detect the position of said movable element using triangulation, pattern-matching and/or position-related code;
bbb. said detector means comprising a digital camera and further comprising a split-screen to capture different views of said surface whereby said different views are calibrated and compared with each other to determine movement and position of the writing element;
ccc. said apparatus comprising two digital cameras to capture different views of the surface whereby the frames of said two digital cameras are calibrated and compared with each other to determine movement and position of said movable element.

15. An apparatus comprising position sensor means for sensing position on a surface further comprising:
a. a position-related means for designating position information,
b. a movable element,
c. a processing means for receiving and processing said at least one output signal, thereby to determine the position of said movable element relative to said surface,
Whereby said position sensor means senses said position-related means and generates at least one output signal thereof.

16. An apparatus according to claim 15 whereby
a. said position-related means comprises at least three points,
b. said at least three points comprising at least two fixed points and at least one movable point,
c. said movable element comprises said at least one movable point, and
d. said apparatus further comprises triangulating means for determining the position and movement of said moveable element.

17. An apparatus according to claim 15 whereby
a. said position-related means comprises at least one pattern, and
b. said apparatus further comprises pattern-matching means for determining the position and movement of said moveable element.

18. An apparatus according to claim 15 whereby said position-related means comprises position-related code means designating two dimensional coordinates of at least one point for determining the position and movement of said moveable element.

19. An apparatus according to claim 15 comprising means for obtaining and outputting the position and movement of a moveable element on a surface selected from the group consisting of
a. triangulating means,
b. pattern-matching means,
c. position-related code means, and
d. any combination thereof.

20. An apparatus according to claim 15 selected from the group consisting of
a. said surface comprising a writing surface;
b. said movable element comprising a writing means for writing on said surface;
c. said surface comprising a substantially two dimensional planar face;
d. said sensor means comprising an array of light sensitive elements for sensing said position-related means and for generating said at least one output signal thereof;
e. said processing means comprising means for receiving and processing said at least one output signal form said position sensor means, thereby to determine the position and movement of said movable element relative to said surface;
f. said moveable element comprising said position sensor means, whereby said movable element is movable relative to said surface;
g. means for determining the path of said moveable element by sensing said position-related means;
h. means for determining the path of said moveable element by sensing a sequence of said position-related means;
i. means for analyzing the path of said moveable element;
j. said position-related means comprising position-related data;
k. said position-related means is printed on said surface;
l. said position-related means is written on said surface;
m. said position-related means comprising existing features on said surface;
n. said position-related means comprising existing features obtainable by said position sensor means;
o. at least part of said position-related means is outside said surface;
p. said surface comprising a writing surface and said movable element comprising a writing means for writing on said surface and whereby said writing means comprises said at least part of said position-related means;
q. said apparatus intended for use with a computer;
r. said apparatus comprising a computer display;
s. said apparatus comprising a computer printer;
t. said apparatus comprising a computer;
u. said apparatus comprising a digital camera;
v. said apparatus comprising writing means for writing on said surface;
w. said apparatus comprising a microcomputer;
x. said apparatus comprising a display;
y. said apparatus comprising function keys;
z. said apparatus comprising an illumination means;
aa. said processing means comprising a computer;
bb. said apparatus comprising a writing means for writing on said surface and further comprising an original hard copy means for forming an original hard copy made by said writing means on said surface;
cc. said surface made of a material selected from the group consisting of paper, plastic, glass, metal, synthetic fiber, synthetic material, natural material, and a paper like substance;
dd. said position-related means comprising a reflecting means for reflecting said position-related means to said position sensor means;
ee. said moveable element selected from the group consisting of a stylus shaped moveable element for hand held use, a hand held moveable element, a cell phone and a stylus shaped cell phone;
ff. said surface comprising an overlay means for overlaying said surface with said position-related means;
gg. said surface comprising an overlay means for overlaying said surface with said position-related means selected from the group consisting of carbon paper, film, template, plate and sheet;
hh. said position-related means comprising a selective reflecting means for selectively reflecting at least one selected frequency of light;
ii. said position sensor means comprising a selective sensing means for selectively sensing at least one selected frequency of light;
jj. said position sensor means comprising a selective sensing means for selectively sensing said position-related means;
kk. said apparatus comprising a pressure switch means for turning on said apparatus when pressure is applied to said movable element;
ll. said apparatus comprising a focusing means for focusing said surface;
mm. said movable element comprising a writing means for writing on said surface;
nn. said movable element comprising a self contained optical stylus, a writing means for writing on said surface, a microcomputer, a user interface means for communicating with a user and a device interface means for communicating with other devices;
oo. said position sensor means selected from the group consisting of said position sensor means mounted on said movable element; said position sensor means mounted on a computer monitor, said position sensor means mounted on a portable computer, said position sensor means mounted to sense said position-related means;
pp. said position sensor means selected from the group consisting of an upper position sensor means, a lower position sensor means, an upper position sensor means and a lower position sensor means mounted in the same direction, an upper position sensor means and a lower position sensor means mounted in opposite directions;
qq. said apparatus further comprising an element selected from the group consisting of a track ball, a pressure sensor, a transducer, a gyroscope, and an accelerometer;
rr. said apparatus comprising a cell phone selected from the group consisting of
said cell phone comprising a mouthpiece, an earpiece, a display, function keys, a pen, a pen retractor, a keypad, a lower digital camera, memory, a microcomputer, power supply and a writing element;
said cell phone comprising a mouthpiece, an earpiece, a display, function keys, a pen, a pen retractor, a keypad, a lower digital camera, memory, a microcomputer, power supply, a writing element, and a lower sensor selected from the group consisting of a track ball, pressure sensor, transducer, gyroscope, and an accelerometer;
said cell phone comprising a portable video camera further comprising a mouthpiece that functions as a microphone, an earpiece that functions as a speaker and a display that functions as a camera display;
said cell phone comprising a portable video camera further comprising a mouthpiece that functions as a microphone, an earpiece that functions as a speaker and a display that functions as a camera display whereby the camera display flips open and twists for viewing and exposing function keys;
said cell phone whereby said cell phone flips open for viewing and exposing function keys and a display;
said cell phone in the shape of a stylus; and
said cell phone for hand held use;
ss. said processing means adapted to produce a digital duplicate of visible marks made on said surface,
tt. said apparatus comprising macro-triangulating means and micro-triangulating means for determining the position and movement of said moveable element;
uu. said apparatus comprising handwriting recognition means for converting handwritten text into a “keyboard-typed” representation;
vv. said surface comprising a repetitive pattern that is made unique by marking said repetitive pattern with said movable element comprising a writing element;
ww. said position sensor means comprising an upper digital camera selected from the group consisting of a video camera, a still camera, video conferencing camera and an internet camera;
xx. said position sensor means comprising a lower digital camera selected from the group consisting of a video camera, a still camera, video conferencing camera and an internet camera;
yy. said position sensor means comprising a lower digital camera that can function as an optical computer mouse;
zz. said apparatus comprising an “ink-well” like interface for said position sensor means to communicate with other devices using means selected form the group consisting of optical means, wireless means and electronic means;
aaa. said position sensor means comprising a digital camera and further comprising mirrors mounted at angles to sense the position of said movable element using triangulation, pattern-matching and/or position-related code;
bbb. said position sensor means comprising a digital camera and further comprising a split-screen to capture different views of said surface whereby said different views are calibrated and compared with each other to determine movement and position of the writing element;
ccc. said apparatus comprising two digital cameras to capture different views of the surface whereby the frames of said two digital cameras are calibrated and compared with each other to determine movement and position of said movable element.
